(19) United States
(12) Patent Application Publication
(10) Pub. No.: US 2026/0203944 A1
(43) Pub. Date: Jul. 16, 2026

(54) AUTOMATED RESOLUTION ASSESSMENT OF AN OPTICAL IMAGING SYSTEM

(71) Applicant: SCHLUMBERGER TECHNOLOGY CORPORATION, Sugar Land, TX (US)

(72) Inventors: Matthias FRANCOIS, Clamart (FR); Can Evren YARMAN, Clamart (FR)

(21) Appl. No.: 19/139,346

(22) PCT Filed: Jan. 24, 2024
(86) PCT No.: PCT/US2024/012703

§ 371 Date: Jun. 15, 2025

(30) Foreign Application Priority Data
Jan. 24, 2023 (EP) 23305091.3

(51) Int. Cl. G06T 7/80; G06F 17/18; G06T 7/13; G06T 7/73; H04N 23/60

(52) U.S. Cl. CPC G06T 7/80; G06F 17/18; G06T 7/13; G06T 7/75; H04N 23/64

(57) ABSTRACT

A method for estimating a spatial resolution of a digital image acquisition system includes acquiring a digital image of an edge feature using a digital image acquisition system; computing a modeled image of the edge feature; and adjusting model parameters in the modeled image to minimize a difference between the digital image of the edge feature and the modeled image of the edge feature to obtain optimized model parameters, wherein at least one of the optimized model parameters is related to a spatial frequency response of the digital image acquisition system. The method may further include adjusting the digital image acquisition system to optimize (or otherwise improve) the spatial resolution thereof.

### CROSS REFERENCE TO RELATED APPLICATIONS

The present application claims priority benefit of European Patent Application No. 23305091.3, filed Jan. 24, 2023, the entirety of which is incorporated by reference herein and should be considered part of this specification.

### BACKGROUND

Calibrated image acquisition is important to numerous image processing and artificial intelligence based image evaluation applications. Such calibrated image acquisition is intended to provide high quality images under robust, repeatable, and quantitatively verifiable conditions. Digital images acquired from a calibrated image acquisition system are intended to be acquired under similar conditions having desired criteria such as brightness, color contrast, sharpness, and the like.

Known calibration procedures commonly include acquiring a digital image of a calibration target including one or more sharp transition areas (e.g., a sharp edge that transitions from black to white) for measuring image sharpness, for example, to calibrate focus and other camera settings. An image acquisition system may be assessed, for example, via evaluating a point spread function (PSF), or one its variants such as edge spread function (ESF) or a line spread function (LSF), to indicate how a point, edge, or line is blurred by the acquisition system.

There is an International Organization for Standardization standard (ISO12233) for estimating the MTF50 of an imaging system. The MTF50 is one measure of the spatial frequency response of an imaging system. The ISO12233 standard computes the absolute value of a discrete Fourier Transform (DFT) of an approximated LSF to estimate the MTF50. While the procedure laid out in ISO12233 is serviceable, there is room for further improvement. In particular, there is a need to improve accuracy and precision, improve robustness to image noise, and to provide an automated calibration methodology.

### BRIEF DESCRIPTION OF THE DRAWINGS

For a more complete understanding of the disclosed subject matter, and advantages thereof, reference is now made to the following descriptions taken in conjunction with the accompanying drawings, in which:

FIG. 1 depicts an example digital image of cuttings particles obtained during a downhole drilling operation.

FIGS. 2A and 2B (collectively FIG. 2) depict flow charts of example methods for estimating the resolution of a digital image acquisition system.

FIG. 3 depicts an example digital acquisition system.

FIG. 4 depicts a flow chart of a method for calibrating the resolution of a digital image acquisition system.

FIG. 5 depicts an image of an example color checker including an edge feature that can be used to estimate the resolution of a digital image acquisition system.

### DETAILED DESCRIPTION

Embodiments of this disclosure include systems and methods for estimating a spatial resolution of a digital image acquisition system. One example method includes acquiring a digital image of an edge feature using a digital image acquisition system; computing a modeled image of the edge feature; and adjusting model parameters in the modeled image to minimize a difference between the digital image of the edge feature and the modeled image of the edge feature to obtain optimized model parameters, wherein at least one of the optimized model parameters is related to a spatial frequency response of the digital image acquisition system. In certain example embodiments, the method may further include adjusting the digital image acquisition system to optimize (or otherwise improve) the spatial resolution thereof.

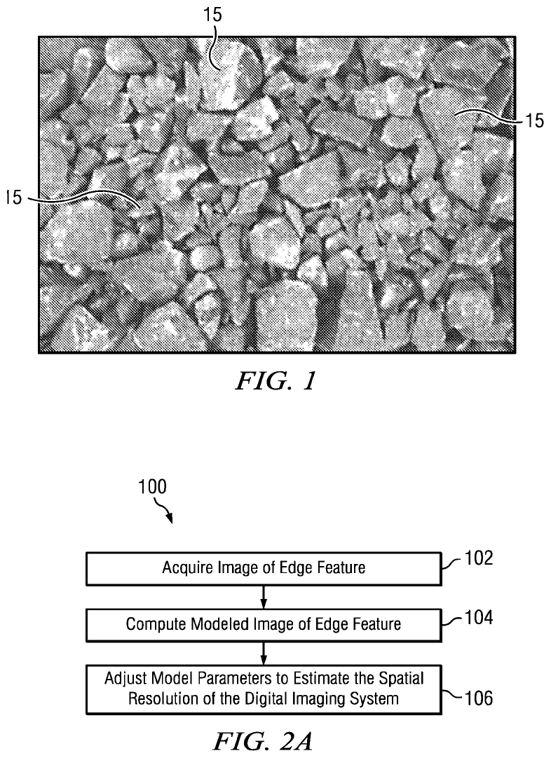

FIG. 1 depicts an example digital image of cuttings particles obtained during a downhole drilling operation. The depicted image includes a large number of cuttings particles 15 placed on a tray. It has long been recognized that rock cuttings particles generated during drilling are abundant in volume and number and may potentially provide one of the lowest cost and most abundant data sources for understanding and characterizing the subsurface formation(s). In recent years there has been considerable interest in developing methods that make use of machine learning (e.g., artificial intelligence and neural network processing) to evaluate digital images of cuttings particles (such those depicted in FIG. 1).

For example, methods have been disclosed to classify formation lithology and to estimate formation porosity from digital images of cuttings particles. Such methods may include acquiring a calibrated digital image of the cuttings particles, segmenting the image to identify individual particles in the image, extracting geometry, color, and/or texture features from the individual particles, and processing the extracted features to classify the lithology and/or estimate the porosity of the formation from which the cuttings were obtained.

It will be appreciated that segmentation and subsequent feature extraction may be highly influenced by the quality of the acquired digital image. For example, a blurry image may significantly increase the difficulty in identifying individual particles during segmentation and/or extracting features from the individual particles (particularly texture related features). Moreover, improper lighting (too much or too little light) may reduce image contrast and may therefore also complicate segmentation and feature extraction. Inconsistent focus and lighting may also increase the difficulty of evaluating (or correlating) the extracted features with particular formation properties or classifications.

Calibration methods have been developed to improve the quality and consistency of acquired digital images. For example, calibrating a digital image acquisition system may include using standardized and/or calibrated lighting, color enhancement, magnification, and/or focus/resolution settings. For example, in certain embodiments, color/illumination calibration is obtained by using colorimetry algorithms against previously analyzed photos and a current photo of interest, while resolution calibration may be based on lens focal length, focal distance, and sensor size/resolution for the current photo of interest as compared to that of previously analyzed photos. Images may be taken when the cuttings are wet or dry, with the humidity generally being controlled for dry cuttings images. Calibration procedures may include evaluating one or more images of a standard calibration target such as a color checker and then making adjustments to system lighting, magnification, and/or focus/resolution settings in response to the image evaluation.

The ISO12233 standard specifies a method for measuring the resolution and the spatial frequency response (SFR) of a digital image acquisition system (e.g., an electronic still-picture camera system). Off-the-shelf software provided by Imatest, LLC (www.imatest.com) is advertised to be based on the ISO12233 standard (www.imatest.com/solutions/iso-12233/). The ISO12233 standard follows the following procedural steps (see FIG. 6 of Parulski, Wueller, Burns, and Yoshida, Creation and Evolution of ISO12233, the International Standard for Measuring Digital Camera Resolution, Image, 347:2, 2022):
(1) Given a region of interest including an edge in a digital image;
(2) Compute orientation and offset of the edge by fitting a line to centroids of each of the rows of the image;
(3) Project each row of the image along the edge axis to obtain a denser sampled version of the observed ESF;
(4) Form a 4× over-sampled version of the observed ESF by binning (averaging the values with quarter pixel width bins) to form an estimate of the ESF;
(5) Approximate the LSF by computing finite difference derivatives of the estimated ESF; and
(6) Take the absolute value of the discrete Fourier transform (DFT) of the approximated LSF to estimate the SFR.

It has been found that the ISO12233 standard methodology is not sufficiently accurate for some digital image applications. For example, sequential estimation of the orientation and centroid of the ESF in (2) and (3) may lead to high mean square errors. Moreover, finite difference differentiation may amplify noise which may be mitigated via filtering, which in turn leads to degraded accuracy. Furthermore, the DFT may be unstable when the LSF doesn't decay sufficiently fast. For at least these reasons, there is a need for improved methods for measuring the resolution and spatial frequency response (SFR) of a digital image acquisition system as well as for calibrating and/or adjusting a digital image system to provide optimal resolution.

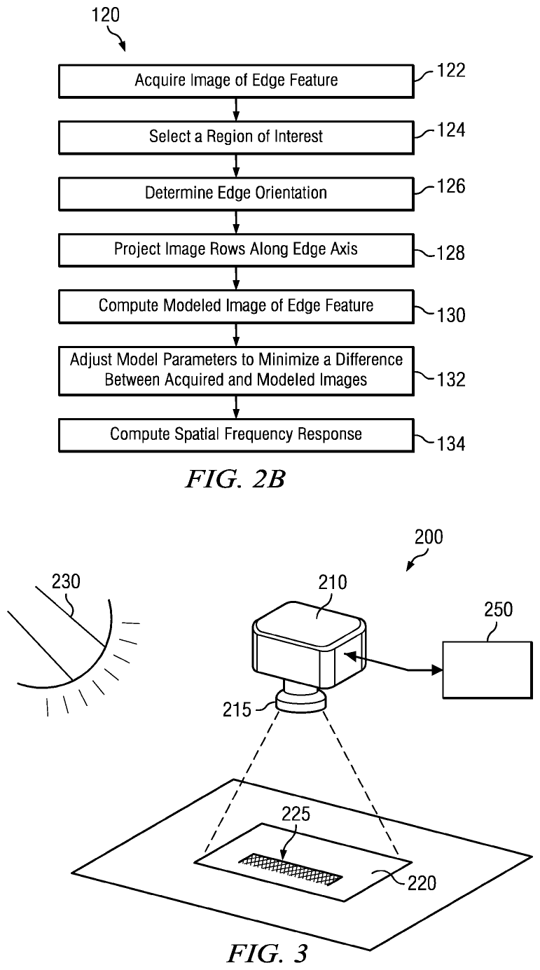

Turning now to FIGS. 2A and 2B (collectively FIG. 2) flow charts of example methods 100 and 120 for estimating the spatial resolution of a digital image acquisition system are depicted. The disclosed embodiments may be used to evaluate substantially any suitable digital image acquisition system configured for acquiring digital images of substantially any suitable object or objects. While the disclosed embodiments may be described with respect to taking calibrated images of drill cuttings (e.g., as depicted in FIG. 1), the disclosed methods are expressly not limited in this regard.

In FIG. 2A, method 100 includes acquiring an image of an edge feature (e.g., in a calibration target) at 102. The image may be acquired, for example, by placing a calibration target, such as a color checker, in a digital image acquisition system including a digital camera and taking a digital image. A desired region of the image may also be selected in 102 (e.g., including an edge feature). The method further includes computing a modeled image of the edge feature or the selected region using a mathematical model at 104 (as described in more detail below). The modeled image may be computed using substantially any suitable mathematical relations, for example, including a Bessel function or a Gaussian function. Method 100 further includes minimizing a difference between the acquired image and the modeled image to optimize model parameters and thereby estimate the spatial resolution of the digital imaging system (e.g., a spatial frequency resolution) at 106. The minimization may include adjusting one or more model parameters used to compute the modeled image in which at least one of the parameters is related to the spatial frequency response of the imaging system. Such parameters may include, for example, a Gaussian variance. Method 100 may further optionally include adjusting the image acquisition system (e.g., refocusing the system) and repeating 102, 104, and 106 to improve the spatial resolution (e.g., the spatial frequency response of the system).

In FIG. 2B, method 120 is similar to method 100 in that it includes acquiring an image of an edge feature (e.g., in a calibration target) at 122. A region of interest of the image is selected at 124. The selected region may include, for example, the edge feature or a portion thereof. The orientation of the edge may be determined at 126, for example, by fitting a line to centroids of each of the rows in the selected region of interest. Since each row is a shifted realization of the ESF, each row may be projected along the edge axis to obtain a more densely sampled version of the observed ESF at 128. A modeled image ESF is computed at 130 (e.g., as described in more detail below). Selected model parameters are adjusted at 132 to minimize a difference between the ESF observed at 128 and the modeled ESF computed at 130. At least one of the model parameters is then further processed at 134 to compute a spatial frequency response of the image acquisition system.

FIG. 3 depicts one example digital image acquisition system 200 suitable for acquiring digital images at 102 and 122 of methods 100 and 120 (FIG. 2). The system includes a camera 210 including a lens 215 such as a zoom lens or a microscopic zoom lens for taking digital images of an object. The camera 210 and lens 215 may include substantially any suitable camera for taking digital images. It will be appreciated that a digital camera, as the term is used herein, is substantially any suitable hardware device that captures digital photographs and stores the digital photographs to digital memory, such as a camera, a smartphone, a tablet, and a webcam. In the depicted embodiment, the camera 210 is deployed above an example calibration target 220, such as color checker or a resolution checker, including an edge feature 225. The system may further optionally include external lighting 230.

With continued reference to FIG. 3, in example embodiments the camera 210 may be electronically connected/coupled with an electronic controller 250. The electronic connection may be configured such that digital images may be transmitted from the camera 210 (e.g., from digital memory in the camera) to the controller 250 and such that instructions/commands may be transmitted from the controller 250 to the camera 210. The controller 250 may include computer hardware and software configured to automatically or semi-automatically evaluate images obtained from the camera (e.g., using the disclosed method embodiments such as methods 100, 120, and/or 150). To perform these functions, the hardware may include one or more processors (e.g., microprocessors) which may be connected to one or more data storage devices (e.g., hard drives or solid state memory). As is known to those of ordinary skill, the processors may be further connected to a network or another computer system. It will, of course, be understood that the disclosed embodiments are not limited the use of or the configuration of any particular computer hardware and/or software.

With reference again to the flowcharts in FIG. 2, the minimizations at 106 and 132 may be represented mathematically, for example, as follows:

$${σ}^{*} = arg {min}_{σ} \{ \frac{{\sum }_{k} \vert I ( {x}_{k} ) - {M}_{σ} ( {x}_{k} ) \vert}{{\sum }_{k} 1} \} \qquad ( 1 )$$

Where σ* represents an optimized parameter that minimizes the difference, I(xₖ) represents the acquired image at pixels xₖ, and M_{σ}(xₖ) represents the modeled image at pixels xₖ. Note that the modeled image M_{σ}(xₖ) is related to a parameter σ (such as a functional variance) that is in turn related to the spatial frequency response of the imaging system. It will be appreciated that the minimization may include adjusting σ in the modeled image to minimize the difference (e.g., to minimize a mean square error) between the acquired image I(xₖ) and the modeled image M_{σ}(xₖ). The value of σ that minimizes the difference (the optimized parameter σ*) may then be taken as an estimate of (or may be further processed to compute) the spatial frequency response of the imaging system.

Example embodiments of methods 100 and 120, as well as Eq. (1), are now described in more detail. An image I(x) with x=[x₁, x₂]∈ [symbol] and x₁, x₂∈ [symbol] may be acquired by an image acquisition system at sample locations

$${\{ {x}_{k} \}}_{k = 1}^{K} .$$

As noted above, given a sample image

$${\{ ( {x}_{k} , I ( {x}_{k} ) ) \}}_{k = 1}^{K} ,$$

it is desirable to determine how sharp an edge is perceived through an imaging system. The ISO12233 standard describe above sets forth a procedure that involves computing the edge spread function (ESF), the line spread function (LSF), and the spatial frequency response (SFR). In particular, the SFR is related to the modulus of the Fourier transform of the LSF, which is also referred to as the modular transfer function (MTF). Half of the peak amplitude of the SFR is referred to as the SFR50 or the MTF50. While the ISO standard may be serviceable for certain applications, there is a need for a method having improved accuracy, particularly for artificial intelligence based image processing applications.

An image with an edge passing through x₀ and making an angle θ from an x₂-axis may be defined by the sampled version of the edge function E(x), for example, as follows:

$$E ( x ) = {a}_{E} H ( {R}_{θ} [ x - {x}_{0} ] \cdot {e}_{1} ) + {b}_{E} = {a}_{E} H ( \hat{θ} - \cdot [ x - {x}_{0} ] ) + {b}_{E}$$

where H(t), t∈ [symbol] is the Heaviside step function:

$$H ( t ) = {\int }_{- ∞}^{t} δ ( z ) dz = \{ \begin{matrix}1 , & t > 0 \\ 0 , & t \leq 0\end{matrix} \}$$

with δ(z)=dₜH(t) being the Dirac delta function and u·ν representing the dot product of two vectors. Moreover in E(x), e₁∈ [symbol] represents the unit vector along x₁ and R_{θ} represents the rotation matrix such that \hat{θ}=R_{θ}e₁=[cos θ, sin θ]∈ [symbol] is the unit vector pointing θ∈[0,2π] radians in the counter clockwise direction from x₁ (i.e., \hat{θ} represents the unit normal direction of the edge).

A line image is defined by the directional gradient of the edge image along some vector ν. Alternatively, a line image may be treated as a sampled version of the line function, as follows:

$$L ( x ) = v \cdot ∇ E ( x )$$

$$= v \cdot ( {a}_{E} θδ ( \hat{θ} \cdot [ x - {x}_{0} ) )$$

$$= ( v \cdot \hat{θ} ) {a}_{E} δ ( \hat{θ} \cdot [ x - {x}_{0} )$$

$$with$$

$$∇ E ( x ) = {a}_{E} \hat{θ} δ ( \hat{θ} \cdot [ x - {x}_{0} ] )$$

Here ∇=(δₓ_{₁}, δₓ_{₂}) is the spatial gradient operator. For ν=\hat{θ}, the line image may be expressed as follows:

$$L ( x ) = \hat{θ} \cdot ∇ E ( x ) = \hat{θ} \cdot ( {a}_{E} \hat{θ} δ ( \hat{θ} \cdot [ x - {x}_{0} ] ) ) = {a}_{E} δ ( \hat{θ} \cdot [ x - {x}_{0} ] )$$

For an optical imaging system, an image of an edge (an edge image) may be approximated by convolution of the edge function with the local point spread function PSF(x), for example, as follows:

$$\begin{matrix}I ( x ) = ( PSF * E ) ( x ) \\ = {\int }_{{ℝ}^{2}} PSF ( x - {x}^{′} ) E ( {x}^{′} ) {dx}^{′} \\ = {a}_{E} {\int }_{{ℝ}^{2}} PSF ( x - {x}^{′} ) H ( θ \cdot [ {x}^{′} - {x}_{0} ] ) {dx}^{′} + {b}_{E} {\int }_{{ℝ}^{2}} PSF ( {x}^{′} ) {dx}^{′}\end{matrix}$$

where I(x) represents the image of the edge. The gradient is given in terms of the gradient of the PSF by (in which the PSF describes the spatial impulse response of the imaging system):

$$∇ I ( x ) = {a}_{E} {\int }_{{ℝ}^{2}} ∇ PSF ( x - {x}^{′} ) H ( \hat{θ} \cdot [ {x}^{′} - {x}_{0} ] ) {dx}^{′}$$

If, without loss of generality, we take θ=0, then, for x=[x₁, x₂],

$${x}^{′} = [ {x}_{1}^{′} , {x}_{2}^{′} ] ,$$

and x₀=[x_{0,1}, x_{0,2}],

$$I ( x ) = {a}_{E} {\int }_{{ℝ}^{2}} ∇ PSF ( x - {x}^{′} ) H ( [ {x}_{1}^{′} + {x}_{1} - {x}_{0 , 1} ] ) {dx}^{′} + {b}_{E} {\int }_{{ℝ}^{2}} PSF ( {x}^{′} ) {dx}^{′}$$

One aspect of the disclosed embodiments, was the realization that the PSF may be approximated using various analytic functions and that such an approximation may enable an ESF to be accurately modeled. For example, a rotationally symmetric analytic point spread function PSF(x)=psƒ(|x|²), may be approximated by a univariate analytic even function ƒₑ(r)=psƒ(r²), for r∈ [symbol] . As described in more detail below, in certain example embodiments, a Gaussian function may be used to approximate the even function up to its second order derivatives at its maxima. This approximation may be further improved using the generalized Padé approximation method presented in Yarman and Flagg, Generalization of Padé approximation from rational functions to arbitrary analytic functions—Theory. Mathematics of Computation, 84(294), 1835-1860, 2015. For example, the analytic function ƒₐ(r)=ƒₒ(r)+i ƒₑ(r), may be obtained by a Hilbert transform ƒₒ(r) of ƒₑ(r), which is an odd function. At its maxima (e.g., r=r₀) a generalized Padé approximation may be used by matching the Taylor series expansion at the maxima, with that of Faddeeva function's w(r) at r=0 to obtain an approximation of the following form:

$${f}_{a} ( r + {r}_{0} ) \approx {\sum }_{m} {α}_{m} F ( {γ}_{m} r )$$

Example functions of this form include Bessel functions and sine cardinal functions (Manzanares, Calvo, Chevalier, and Lakshminarayanan, Line spread function formulation proposed by WH Steel: a revision. Applied optics, 36(19), pp. 4362-4366, 1997).

In the example embodiments that follow, the PSF is approximated as a Gaussian as follows:

$$PSF ( x ) \approx {a ( \frac{1}{\sqrt{2 {πσ}^{2}}} )}^{2} {e}^{- \frac{{\vert x \vert}^{2}}{2 {σ}^{2}}}$$

such that

$$I ( x ) \approx {a}_{E} {\int }_{{ℝ}^{2}} {a ( \frac{1}{\sqrt{2 {πσ}^{2}}} )}^{2} {e}^{- \frac{{( {x}_{1}^{′} )}^{2} + {( {x}_{2}^{′} )}^{2}}{2 {σ}^{2}}} H ( [ {x}_{1}^{′} + {x}_{1} - {x}_{0 , 1} ] ) {dx}_{1}^{′} {dx}_{2}^{′} + {ab}_{E} = {a}_{E} {\int }_{{ℝ}^{2}} a ( \frac{1}{\sqrt{2 {πσ}^{2}}} ) {e}^{- \frac{{( {x}_{1}^{′} )}^{2}}{2 {σ}^{2}}} H ( [ {x}_{1}^{′} + {x}_{1} - {x}_{0 , 1} ] ) {dx}_{1}^{′} + {ab}_{E} = {\int }_{- ∞}^{{x}_{1} - {x}_{0 , 1}} a ( \frac{1}{\sqrt{2 {πσ}^{2}}} ) {e}^{- \frac{{( {x}_{1}^{′} )}^{2}}{2 {σ}^{2}}} {dx}_{1}^{′} + {ab}_{E} = {a}_{E} {aCDF}_{σ} ( {x}_{1} - {x}_{0 , 1} ) + {ab}_{E}$$

The gradient may also be similarly approximated as follows:

$$∇ I ( x ) \approx {e}_{1} {a}_{E} a {g}_{σ} ( {x}_{1} - {x}_{0 , 1} )$$

$${e}_{1} \cdot ∇ I ( x ) \approx {e}_{1} {a}_{E} a {g}_{σ} ( {x}_{1} - {x}_{0 , 1} )$$

where g_{σ}(x), for x∈ [symbol] , is the dilated Gaussian function and CDF_{σ}(x) is an integral of a dilated Gaussian such that:

$${g}_{σ} ( x ) = \frac{1}{σ} g ( \frac{x}{σ} ) = \frac{1}{\sqrt{2 {πσ}^{2}}} {e}^{- \frac{{x}^{2}}{2 {σ}^{2}}} = \frac{1}{\sqrt{2 {πσ}^{2}}} {\sum }_{n = 0}^{∞} \frac{( - 1 )}{n ! {2}^{n} {σ}^{2 n}} {x}^{2 n}$$

$${CDF}_{σ} ( x ) = {\int }_{- ∞}^{x} {g}_{σ} ( {x}^{′} ) {dx}^{′} = \frac{1}{2} ( 1 + erf ( \frac{x}{\sqrt{2 {σ}^{2}}} ) )$$

where erf(·) represents the error function. For an arbitrary rotation angle θ, the forgoing may be generalized, for example, as follows:

$$I ( x ) \approx {M}_{σ} ( x ) = {a}_{E} {aCDF}_{σ} ( \hat{θ} \cdot [ x - {x}_{0} ] ) + {ab}_{E} \qquad ( 2 )$$

$$∇ I ( x ) \approx ∇ {M}_{σ} ( x ) = \hat{θ} {a}_{E} {ag}_{σ} ( \hat{θ} \cdot [ x - {x}_{0} ] )$$

Now consider a coordinate frame defined by \hat{θ} and \hat{θ}^{⊥} where x=\hat{θ}x₁+\hat{θ}^{⊥}+x₂, for x₁, x₂∈ [symbol] . For a rotationally symmetric PSF, the edge and line spread functions ESF(x) and LSF(x) may be defined and approximated, for example, as follows:

$$ESF ( {x}_{1} ) = \frac{\int I ( x + \hat{θ} \cdot {x}_{0} ) {dx}_{2}}{\int {dx}_{2}} \approx {aCDF}_{σ} ( {x}_{1} )$$

$$LSF ( {x}_{1} ) = \frac{\int \hat{θ} \cdot ∇ I ( x + \hat{θ} \cdot {x}_{0} ) {dx}_{2}}{\int {dx}_{2}} \approx {ag}_{σ} ( {x}_{1} )$$

where the x₂ integration is considered over the support of the image. For an arbitrary coordinate frame defined by ν₁ and ν₂ in [symbol] , where x=ν₁x₁+ν₂x₂ for some x₁, x₂∈ [symbol] , it follows that:

$$\begin{matrix}I ( {v}_{1} {x}_{1} + {v}_{2} {x}_{2} ) = {a}_{E} ESF ( ( \hat{θ} \cdot {v}_{1} ) {x}_{1} + ( \hat{θ} \cdot {v}_{2} ) {x}_{2} - \hat{θ} \cdot {x}_{0} ) + {ab}_{E} \\ \approx {M}_{σ} ( {v}_{1} {x}_{1} + {v}_{2} {x}_{2} ) \\ = {aa}_{e} {CDF}_{σ} ( ( \hat{θ} \cdot {v}_{1} ) {x}_{1} + ( \hat{θ} \cdot {v}_{2} ) {x}_{2} - \hat{θ} \cdot {x}_{0} ) + {ab}_{E}\end{matrix}$$

For ν₁=\hat{θ} and ν₂=\hat{θ}^{⊥} (i.e., when the arbitrary coordinate frame is aligned with \hat{θ} and \hat{θ}^{⊥}), the foregoing may be simplified, for example, as follows:

$$\begin{matrix}I ( \hat{θ} {x}_{1} + {\hat{θ}}^{⊥} {x}_{2} ) = {a}_{E} ESF ( {x}_{1} - \hat{θ} \cdot {x}_{0} ) + {ab}_{E} \\ \approx {M}_{σ} ( \hat{θ} {x}_{1} + {\hat{θ}}^{⊥} {x}_{2} ) \\ = {aa}_{e} {CDF}_{σ} ( {x}_{1} - \hat{θ} \cdot {x}_{0} ) + {ab}_{E}\end{matrix}$$

It will be appreciated that sampling the image along \hat{θ} by varying x₁, leads to sampling along the ESF. When ν₁ is a unit vector different than \hat{θ}, then |\hat{θ}·ν₁|<1 and error made in the estimation of the orientation of the edge can be perceived as dilation of the ESF which consequently translates to a reduction of the resolution. Approximations of I(ν₁x₁+ν₂x₂) and I(\hat{θ}x₁+\hat{θ}^{⊥}+x₂) form the basis of the ESF estimation for the ISO12233 standard where each row of an edge image is perceived as a dilated and translated version of the ESF.

With reference again to FIG. 2, method 100 includes minimizing a difference between an acquired image and a modeled image to determine an edge resolution at 106 and 132 (e.g., as given generally in Eq. (1)). Two particular embodiments follow in which an ESF is obtained by approximating the PSF as a Gaussian function.

In a first embodiment, method 120 (FIG. 2B) minimizes a difference (or misfit) between a modeled ESF and a sampled ESF (an acquired image) at 132. The modeled ESF is given using Eq. (2) by M_{σ}(\hat{θ}x₁+\hat{θ}^{⊥}+x₂). The minimization may include minimizing a mean square error, for example, as follows:

$$( {a}^{*} , {b}^{*} , {σ}^{*} , {x}_{0}^{*} ) = arg {min}_{( a , b , σ , {x}_{0} ) ∈ {ℝ}^{4}} \{ \frac{{\sum }_{k} {\vert I ( \hat{θ} {x}_{1 , k} + {\hat{θ}}^{⊥} {x}_{2 , k} ) - {aCDF}_{σ} ( {x}_{1 , k} - {x}_{0} ) + b \vert}^{2}}{{\sum }_{k} 1} \} \qquad ( 3 )$$

where I(\hat{θ}x_{1,k}+\hat{θ}^{⊥}x_{2,k}) represents the sampled ESF (the acquired image) having a known orientation, aCDF_{σ}(x_{1,k}−x₀)+b represents the modeled ESF, a, b, σ, and x₀ represent the model parameters that are adjusted in the minimization (in which a and b represent gain and offset parameters, σ represents a Gaussian variance, and x₀ represents an image shift observed by ESF), and a*, b*, σ*, and

$${x}_{0}^{*}$$

represents the optimal parameter values at the minimum mean square error. In this embodiment, the sampled image of known orientation I(\hat{θ}x_{1,k}+\hat{θ}+x_{2,k}) is fit via optimizing the model parameters and a spatial image shift x₀. Note that in this embodiment the model parameter σ is the Gaussian variance, which, as described in more detail below, is related to the spatial frequency resolution of the image acquisition system.

In a second embodiment, method 100 (FIG. 2A) minimizes a difference (or misfit) between a modeled image M_{σ}(x) and a sampled image I(x) (an acquired image) at 106. The modeled image is given in Eq. (2) for an arbitrary rotation angle. The minimization may include minimizing a mean square error, for example, as follows:

$$( {a}^{*} , {b}^{*} , {σ}^{*} , {x}_{0}^{, *} , {\hat{θ}}^{*} ) = arg {min}_{( a , b , σ , {x}_{0} , \hat{θ} ) ∈ {ℝ}^{5} \times {s}_{1}} \{ \frac{{\sum }_{k} {\vert I ( {x}_{k} ) - {aCDF}_{σ} ( \hat{θ} \cdot [ {x}_{k} - {x}_{0} ] ) + b \vert}^{2}}{{\sum }_{k} 1} \} \qquad ( 4 )$$

where I(xₖ) represents the sampled ESF(the acquired image) having an unknown orientation, aCDF_{σ}(\hat{θ}·[xₖ−x₀]) represents the modeled ESF, a, b, σ, x₀, and \hat{θ} represent the model parameters that are adjusted in the minimization (in which a and b represent gain and offset parameters, σ represents a Gaussian variance, x₀ represents an image shift observed by ESF, and \hat{θ} represents an angular orientation of the edge), and a*, b*, σ*,

$${x}_{0}^{*} ,$$

and \hat{θ}* represent the parameter values at the minimum mean square error. Note that in this second embodiment, the sampled image I(xₖ) is fit via optimization of the modeled ESF parameters, the spatial image shift x₀, and the unknown orientation of the edge \hat{θ}. This second embodiment, may be advantageous in that it does not require the orientation of the edge to be separately computed (e.g., as in 126 of method 120). Again, once the optimal σ* is obtained, the spatial frequency resolution of the image acquisition system may be further computed as described in more detail below.

With continued reference to FIG. 2, and Eqs. (3) and (4), the spatial frequency response of the imaging system may be computed from the optimal σ*. The spatial frequency response SFR(x) is defined as the magnitude of the Fourier transform of the line spread function, as follows:

$$\text{?} ( k ) = {\int }_{- ∞}^{∞} LSF ( x ) {e}^{- i 2 π kx} dx$$

$$SFR ( k ) = \vert \text{?} ( k ) \vert$$

Note that SFR is invariant under translation of the LSF, such that:

$$\vert {\int }_{- ∞}^{∞} LSF ( x + Δ x ) {e}^{- i 2 π kx} dx \vert = \vert \text{?} ( k ) {e}^{- i 2 π k Δ x} \vert = SFR ( k )$$

It will be appreciated that the Fourier transform of a dilated Gaussian is also a dilated Gaussian. Therefore, when the PSF is approximated as a Gaussian (as in example embodiments described above), the SFR may be approximated, for example, as given below:

$$\begin{matrix}SFR ( k ) \approx \vert a {\hat{g}}_{σ} ( k ) \vert \\ = \vert a 2 π σ \sqrt{2 π} {g}_{{( 4 {π}^{2} {σ}^{2} )}^{- 1 / 2}} ( k ) \vert\end{matrix} \qquad ( 5 )$$

where

$$MTF50 = {k}_{\text{.5}} \approx \sqrt{2 {( 2 π σ )}^{- 2} \cdot ln 2}$$

is the Fourier transform of the dilated Gaussian g_{σ}. The value of k where SFR(k) is half of its peak height is referred to as the SFR50 or the MTF50, and is used in the ISO12233 standard as an indicator of image sharpness. For a positive function, SFR(k) obtains its maximum height at k=0. The MTF50 may be found at k_{0.5}, which for Gaussian approximation is as follows:

$${\hat{g}}_{σ} = 2 π σ \sqrt{2 π} {g}_{{( 4 {π}^{2} {σ}^{2} )}^{- 1 / 2}}$$

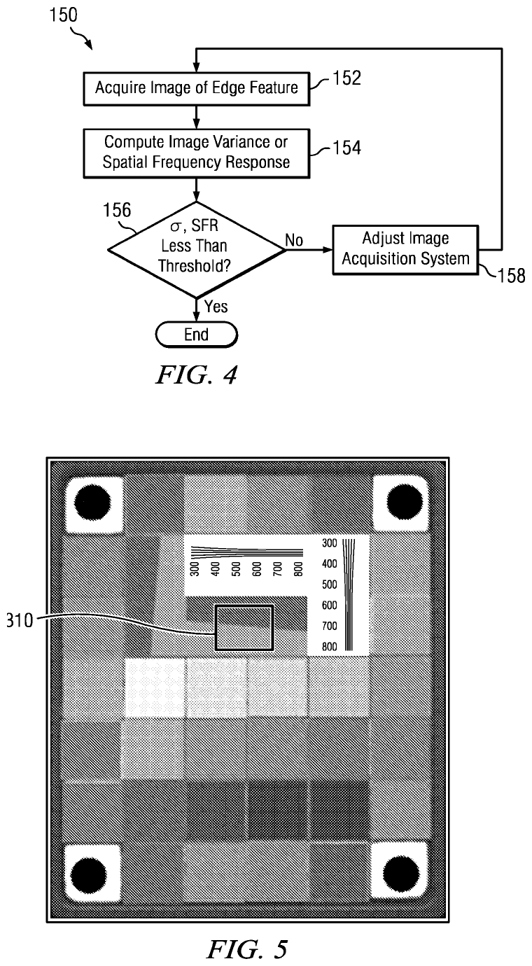

Turning now to FIG. 4, a flow chart of another disclosed method 150 is depicted. Method 150 includes a feedback loop that enables image acquisition parameters to be optimized. An image is acquired at 152 and processed to compute an image variance σ and/or SFR at 154, for example, as described above with respect to methods 100 and 120. The variance σ and/or SFR is compared with a corresponding threshold at 156. When the variance σ or SFR is less than the threshold, the image acquisition system is taken to be optimized (or calibrated). When the variance σ or SFR is greater than the threshold, the image acquisition system is adjusted at 158. The method then returns to 152 and the acquisition of another image. The adjustment(s) to the image acquisition system at 158 may include substantially any suitable adjustment, for example, including camera settings such as focus and sensor saturation, lighting settings such as illumination direction, color, intensity, and/or power, and atmospheric conditions such as temperature and humidity. These settings may be adjusted manually or automatically. Camera settings, in particular, such as focus may be automatically adjusted such that certain advantageous embodiments of method 150 may include an automated focus calibration method.

With continued reference to FIG. 4, method 150 may be thought of mathematically as an optimization problem. An image I_{c}(x) may be thought of as being parameterized by c in which the parameters may include the camera, lighting, and environmental settings noted above. Optimal image acquisition and operating parameters may be determined in method 150, for example, as follows:

$${c}^{*} = {min}_{c} {σ}^{*} ( c )$$

where

$$( {a}^{*} ( c ) , {b}^{*} ( c ) , {σ}^{*} ( c ) , {x}_{0}^{*} ( c ) , {\hat{θ}}^{*} ( c ) ) = arg {min}_{( a , b , σ , {x}_{0} , \hat{θ} ) ∈ {ℝ}^{5} \times {s}_{1}} \{ \frac{{\sum }_{k} {\vert {I}_{c} ( {x}_{k} ) - {aCDF}_{σ} ( \hat{θ} \cdot [ {x}_{k} - {x}_{0} ] ) + b \vert}^{2}}{{\sum }_{k} 1} \}$$

$$or$$

$$( {a}^{*} ( c ) , {b}^{*} ( c ) , {σ}^{*} ( c ) , {x}_{0}^{*} ( c ) ) = arg {min}_{( a , b , σ , {x}_{0} ) ∈ {ℝ}^{4}} \{ \frac{{\sum }_{k} {\vert I ( \hat{θ} {x}_{1 , k} + {\hat{θ}}^{⊥} {x}_{2 , k} ) - {aCDF}_{σ} ( {x}_{1 , k} - {x}_{0} ) + b \vert}^{2}}{{\sum }_{k} 1} \}$$

and where c* represents the optimized image acquisition parameters and σ*(c) represents the optimized variance parameter at c obtained, for example, as described above with respect to Eqs. (3) and (4). It will be appreciated that since σ*(c) may be taken as a measure of resolution (resolution increases with decreasing σ*(c)), optimal imaging acquisition parameters c may be obtained by minimizing σ*(c).

It will be appreciated that the computational complexity of each of the first and second embodiments described above tends to be dominated by the optimization step (given in Eqs. (3) and (4)). When the optimization is performed by a gradient descent (GD) approach, the computational complexity is in the order of N×4×GD and N×6×GD for the first and second embodiments in Eqs. (3) and (4), where N represents the number of pixels in the image and GD represents the number of iterations in the optimization. The computational complexity of the ISO12233 method is dominated by the discrete Fourier transform, which is on the order of N ln(N). For an image with N≈200×200=40,000 pixels, ln(N)≈10.6 making the disclosed methods computationally competitive when the number of GD iterations is small. This may be achieved, for example, with good initialization. As shown in the Examples below, any increase in the number of computations tends to be rewarded with improved accuracy and robustness.

The disclosed embodiments are described in more detail by way of the following non-limiting examples in which the performance of the first and second embodiments described above with respect to Eqs. (3) and (4) was compared with that of the ISO12233 methodology for synthetic images (Table 1) and Imatest rez-checker (www.imatest.com/product/rez-checker/) images obtained using digital light microscopy (Table 2). In Table 1, synthetic images were generated using the model image in Eq. (2) with and without added noise for a high resolution image (σ=1) and a low resolution image (σ=3). The spatial frequency response (SFR50) of each image was computed using the ISO12233 procedure and each of the first and second embodiments described above with respect to Eqs. (3) and (4). The SFR50 of the first and second embodiments was obtained using Eq. (5). The mean square error (MSE) of each image was also computed using the ISO12233 procedure (via comparing steps 3 and 4) and each of the first and second embodiments (the numerators in Eqs (3) and (4)). The results are shown in Table 1.

TABLE 1

| | | SFR50 | SFR50 | | MSE | MSE | |
|---|---|---|---|---|---|---|---|
| | Known | Emb #1 | Emb #2 | SFR50 | Emb #1 | Emb #2 | MSE |
| Image | SFR50 | Eq. (3) | Eq. (4) | ISO12233 | Eq. (3) | Eq. (4) | ISO12233 |
| (σ = 1) | 149.91 | 151.07 | 151.14 | 168.0 | 6.93E−07 | 7.27E−07 | 3.99E−04 |
| Noiseless | | | | | | | |
| (σ = 1) | 149.91 | 149.68 | 158.81 | 183.5 | 5.27E−03 | 3.31E−03 | 6.45E−03 |
| w/Noise | | | | | | | |
| (σ = 3) | 49.97 | 49.07 | 50.06 | 64.68 | 7.38E−07 | 1.25E−06 | 1.77E−03 |
| Noiseless | | | | | | | |
| (σ = 3) | 49.97 | 49.08 | 49.80 | 60.85 | 5.07E−03 | 3.34E−04 | 5.27E−03 |
| w/Noise | | | | | | | |

As is evident from the results set forth in Table 1, The SFR50 values obtained using the first and second embodiments are much closer to the known SFR50 values than the SFR50 values obtained via the ISO12233 standard method for each of the images. Moreover, the mean MSE values obtained using the first and second embodiments are lower than the MSE values obtained via the ISO12233 standard method for each of the images.

In Table 2, three images were evaluated. The images were obtained at three lighting levels (low, medium, and high or dark, moderate, and bright). FIG. 5 depicts an image of the Imatest rez-checker with the selected feature 310 that was evaluated indicated. The SFR50 and MSE of each image was computed using each of the first and second embodiments described above with respect to Eqs. (3) and (4) and the ISO12233 methodology. The results are shown in Table 2.

TABLE 2

| | SFR50 | SFR50 | | MSE | MSE | |
|---|---|---|---|---|---|---|
| | Emb #1 | Emb #2 | SFR50 | Emb #1 | Emb #2 | MSE |
| Image | Eq. (3) | Eq. (4) | ISO12233 | Eq. (3) | Eq. (4) | ISO12233 |
| Low | 81.35 | 59.64 | 71.84 | 2.45E−03 | 2.23E−03 | 2.51E−03 |
| Medium | 110.20 | 82.11 | 100.90 | 1.85E−03 | 1.69E−03 | 2.28E−03 |
| High | 101.66 | 76.58 | 97.40 | 1.41E−03 | 1.13E−03 | 2.45E−03 |

As is evident from the results set forth in Table 1, the mean MSE values obtained using the first and second embodiments are lower than the MSE values obtained via the ISO12233 standard method for each of the images, indicating that these methods provide improved precision as compared to the ISO12233 method.

It will be understood that the present disclosure includes numerous embodiments. These embodiments include, but are not limited to, the following embodiments.

In a first embodiment, a method for estimating a spatial resolution of a digital image acquisition system comprises acquiring a digital image of an edge feature using a digital image acquisition system; computing a modeled image of the edge feature using a mathematical model; and adjusting parameters in the mathematical model to minimize a difference between the digital image of the edge feature and the modeled image of the edge feature to obtain optimized model parameters, wherein at least one of the optimized model parameters is related to a spatial frequency response of the digital image acquisition system.

A second embodiment may include the first embodiment, wherein the mathematical model comprises an edge function that includes a point spread function of the digital image acquisition system, wherein the point spread function of the digital image acquisition system is estimated with a univariate analytic even function.

A third embodiment may include the second embodiment, wherein the univariate analytic even function is a Gaussian function.

A fourth embodiment may include any one of the first through third embodiments, wherein the mathematical model comprises an integral of a dilated Gaussian evaluated at pixel positions of the acquired image.

A fifth embodiment may include any one of the first through fourth embodiments, wherein the at least one of the optimized parameters in the mathematical model comprises a Gaussian variance.

A sixth embodiment may include any one of the first through fifth embodiments, further comprising estimating an angular orientation of the edge feature, wherein the parameters in the mathematical model comprise a gain parameter, an offset parameter, a Gaussian variance, and an image shift.

A seventh embodiment may include any one of the first through sixth embodiments, wherein the parameters in the mathematical model comprise a gain parameter, an offset parameter, a Gaussian variance, an image shift, and an angular orientation of the edge feature.

An eighth embodiment may include any one of the first through seventh embodiments, wherein the difference between the digital image of the edge feature and the modeled image of the edge feature comprises a mean square error.

A ninth embodiment may include any one of the first through eighth embodiments, further comprising computing the spatial frequency response of the imaging acquisition system using the at least one of the optimized parameters in the mathematical model.

A tenth embodiment may include any one of the first through ninth embodiments, further comprising adjusting the image acquisition system in response to the at least one of the optimized parameters in the mathematical model; and repeating the acquiring digital image, the computing the modeled image, and the adjusting the parameters in the mathematical model to calibrate the digital imaging system.

In an eleventh embodiment a system for taking digital images comprises a digital camera and a processor configured to: cause the digital camera to take a digital image of an object including an edge feature; compute a modeled image of the edge feature using a mathematical model; and adjust parameters in the mathematical model to minimize a difference between the digital image and the modeled image of the edge feature to obtain optimized model parameters, wherein at least one of the optimized model parameters is related to a spatial frequency response of the digital image acquisition system.

A twelfth embodiment may include the eleventh embodiment, wherein the mathematical model comprises an integral of a dilated Gaussian evaluated at pixel positions of the acquired image; and the at least one of the parameters in the mathematical model comprises a Gaussian variance.

A thirteenth embodiment may include any one of the eleventh through twelfth embodiments, wherein the parameters in the mathematical model comprise at least a Gaussian variance and an angular orientation of the edge feature.

A fourteenth embodiment may include any one of the eleventh through thirteenth embodiments, wherein the processor is further configured to compute the spatial frequency response of the digital camera using the at least one of the optimized parameters in the mathematical model.

A fifteenth embodiment may include any one of the eleventh through fourteenth embodiments, wherein the processor is further configured to automatically adjust a setting on the digital camera in response to the at least one of the optimized parameters in the mathematical model; cause the digital camera to take another digital image of the object including the edge feature; compute another modeled image of the edge feature; and adjust the parameters in the mathematical model to minimize a difference between the another digital image and the another modeled image of the edge feature to obtain optimized parameters in the mathematical model.

In a sixteenth embodiment, a method for calibrating a spatial resolution of a digital image acquisition system comprises acquiring a digital image of an edge feature using a digital image acquisition system; compute a modeled image of the edge feature using a mathematical model; adjusting model parameters to minimize a difference between the digital image of the edge feature and the modeled image of the edge feature to obtain optimized model parameters; compute a spatial frequency response of the digital acquisition system using the at least one of the optimized parameters in the mathematical model; adjusting a setting of the digital acquisition system in response to the computed spatial frequency response; and repeating the acquiring a digital image, the computing the modeled image, the adjusting parameters in the mathematical model, the computing a spatial frequency response, and the adjusting the setting to optimize the spatial frequency response of the digital image acquisition system.

A seventeenth embodiment may include the sixteenth embodiment, wherein the adjusting a setting and the repeating the acquiring are performed automatically.

An eighteenth embodiment may include any one of the sixteenth through seventeenth embodiments, wherein the mathematical model comprises an integral of a dilated Gaussian with respect to pixel position in the modeled image; and the at least one of the parameters in the mathematical model comprises a Gaussian variance.

A nineteenth embodiment may include any one of the sixteenth through eighteenth embodiments, wherein the parameters in the mathematical model comprise at least a Gaussian variance and an angular orientation of the edge feature.

A twentieth embodiment may include any one of the sixteenth through nineteenth embodiments, wherein the parameters in the mathematical model comprise at least a gain parameter, an offset parameter, a Gaussian variance, and an image shift.

Although automated resolution assessment of an optical imaging system has been described in detail, it should be understood that various changes, substitutions and alternations can be made herein without departing from the spirit and scope of the disclosure as defined by the appended claims.

1. A method for estimating a spatial resolution of a digital image acquisition system, the method comprising:
acquiring a digital image of an edge feature using a digital image acquisition system;
computing a modeled image of the edge feature using a mathematical model; and
adjusting parameters in the mathematical model to minimize a difference between the digital image of the edge feature and the modeled image of the edge feature to obtain optimized model parameters, wherein at least one of the optimized model parameters is related to a spatial frequency response of the digital image acquisition system.

2. The method of claim 1, wherein the mathematical model comprises an edge function that includes a point spread function of the digital image acquisition system, wherein the point spread function of the digital image acquisition system is estimated with a univariate analytic even function or a Gaussian function.

3. The method of claim 1, further comprising estimating an angular orientation of the edge feature, wherein the parameters in the mathematical model comprise a gain parameter, an offset parameter, a Gaussian variance, and an image shift.

4. The method of claim 1, wherein the difference between the digital image of the edge feature and the modeled image of the edge feature comprises a mean square error.

5. A system for taking digital images, the system comprising:
a digital camera; and
a processor configured to:
cause the digital camera to take a digital image of an object including an edge feature;
compute a modeled image of the edge feature using a mathematical model; and
adjust parameters in the mathematical model to minimize a difference between the digital image and the modeled image of the edge feature to obtain optimized model parameters, wherein at least one of the optimized model parameters is related to a spatial frequency response of the digital image acquisition system.

6. The system of claim 5, wherein:
the mathematical model comprises an integral of a dilated Gaussian evaluated at pixel positions of the acquired image; and
the at least one of the parameters in the mathematical model comprises a Gaussian variance.

7. The system of claim 5, wherein the processor is further configured to compute the spatial frequency response of the digital camera using the at least one of the optimized parameters in the mathematical model.

8. The system of claim 5, wherein the processor is further configured to:
automatically adjust a setting on the digital camera in response to the at least one of the optimized parameters in the mathematical model;
cause the digital camera to take another digital image of the object including the edge feature;
compute another modeled image of the edge feature; and
adjust the parameters in the mathematical model to minimize a difference between the another digital image and the another modeled image of the edge feature to obtain optimized parameters in the mathematical model.

9. A method for calibrating a spatial resolution of a digital image acquisition system, the method comprising:
acquiring a digital image of an edge feature using a digital image acquisition system;
compute a modeled image of the edge feature using a mathematical model;
adjusting model parameters to minimize a difference between the digital image of the edge feature and the modeled image of the edge feature to obtain optimized model parameters;
compute a spatial frequency response of the digital acquisition system using the at least one of the optimized parameters in the mathematical model;
automatically adjusting a setting of the digital acquisition system in response to the computed spatial frequency response; and
automatically repeating the acquiring a digital image, the computing the modeled image, the adjusting parameters in the mathematical model, the computing a spatial frequency response, and the adjusting the setting to optimize the spatial frequency response of the digital image acquisition system.

10. The method of claim 9, wherein:
the mathematical model comprises an integral of a dilated Gaussian with respect to pixel position in the modeled image; and
the at least one of the parameters in the mathematical model comprises a Gaussian variance.
